(19) United States
(12) Patent Application Publication
(10) Pub. No.: US 2024/0394536 A1
(43) Pub. Date: Nov. 28, 2024

(54) PROCESSING DATA WITH NEURAL NETWORKS ON LIMITED HARDWARE RESOURCES

(71) Applicant: Robert Bosch GmbH, Stuttgart (DE)

(72) Inventor: Jens Eric Markus Mehnert, Malmsheim (DE)

(21) Appl. No.: 18/664,375

(22) Filed: May 15, 2024

(30) Foreign Application Priority Data
May 26, 2023 (DE) 10 2023 204 987.2

(51) Int. Cl. G06N 3/082

(52) U.S. Cl. CPC G06N 3/082

(57) ABSTRACT

A method (100) for processing input data x with a neural network (1) that comprises a set N of neurons (11-19), having the steps:
according to a given negative metric (2), the subset P⊂N of neurons (11-19) is determined (110) whose use can be omitted without unduly impairing the performance of the neural network (1);
according to a given positive metric (3), the subset A⊂(N\P) of those neurons (11-19) that significantly contribute to the processing of the specific input data x is determined (120) from the subset N\P;
for processing the specific input data x, a subset D⊂N of neurons (11-19) is selected (130), which is a superset D⊇A of the set A;
the input data x are processed into output data y (140) using the neurons (11-19) of the set D.

### FIELD

The present invention relates to the processing of data with neural networks on hardware platforms with limited resources such as those used, for example, in control units for vehicles and in other embedded systems.

### BACKGROUND INFORMATION

Driving a vehicle in road traffic can be learned in a relatively small number of driving lessons and over a manageable number of kilometers. Typically, a learner driver spends only a few tens of hours behind the wheel and covers less than 1000 km before taking the driving test. The human driver is then nevertheless able to drive the vehicle safely, even in many situations not seen in the training. His brain is able to generalize from training to these so far unseen situations.

In order to also incorporate precisely this capability into the at least partially automated driving of vehicles, neural networks are used, for example in the evaluation of measurement data that are obtained by monitoring the vehicle's surroundings with sensors. The greater the capabilities of such neural networks become, the greater will be the demands placed on the hardware platform by the implementation. However, embedded hardware for mobile use in particular is significantly more expensive per unit of performance than, for example, desktop or server hardware for stationary use. This is especially true of embedded hardware with an increased safety integrity level (SIL).

### SUMMARY

The present invention provides a method for processing input data x with a neural network. This neural network consists of a set N of neurons.

According to an example embodiment of the present invention, as part of the procedure, the subset P c N of neurons whose use can be omitted without unduly impairing the performance of the neural network is first determined according to a given negative metric. Omitting a portion of the neurons is also called “network pruning.”

From the subset N\P still obtained after pruning, the subset A⊂(N\P) of those neurons that significantly contribute to the processing of the specific input data x is determined according to a prespecified positive metric. This subset A can therefore in particular be different, for example for each input datum x, i.e. A=A(x).

To process the specific input data x, a subset D⊂N of neurons is selected, which is a superset D⊇A of the set A. In the simplest case, D=A. However, it is also possible to include additional neurons in the set D according to any other criteria, for example if only a small number A(x) of neurons is absolutely necessary for processing the specific input data x, and a given budget for processing capacity has not yet been exhausted.

It has been found that network pruning using the negative metric on the one hand and the selection of neurons by using the positive metric on the other hand work together synergistically. The negative metric can be evaluated particularly quickly and can already identify on the scale of between 80% and, in extreme cases, 99% of the neurons as not being important. Examining the set N\P remaining after pruning for neurons that are important for processing specific input data x requires an effort that scales more strongly than linearly with the number of neurons remaining. The preselection of neurons by pruning thus saves a considerable amount of computing time and in return makes it possible to spend more time per remaining neuron on deciding whether this neuron is also important for processing the specific input data x. As a result, the processing can be performed with significantly fewer neurons than the architecture of the neural network originally envisions without the quality of the outputs y suffering or the outputs y being unduly delayed.

This is somewhat comparable to the selection process at a university. In particular, in majors admission to which is not restricted or only vaguely restricted by the GPA, such as computer science or physics, a large number of students initially apply. In the early semesters, pruning is therefore carried out by first setting challenging exams in basic subjects such as mathematics. Using this negative metric, an originally fully occupied auditorium can be reduced to an occupancy of between a quarter to a fifth with comparatively little effort. From the remaining set of students, the positive metrics of more supervision-intensive courses, such as seminars, can then be used to select those students who actually have what it takes to excel in computer science or physics. After their graduation, these students are taken on as research assistants in the departments.

According to an example embodiment of the present invention, the input data x of the neural network can in particular be, for example, pixel values of images or values with which points of point clouds are annotated. Images can be, for example, camera images, video images, thermal images or ultrasound images. Radar measurements and lidar measurements, on the other hand, usually provide as results point clouds that assign one or more measured quantities to points in space. Ultrasound measurements can also provide point clouds as results.

According to an example embodiment of the present invention, the output data y of the neural network can in particular comprise, for example, classification scores with respect to one or more classes of a given classification. Particularly in applications in vehicles, driver assistance systems and robots, these classes can, for example, represent types of objects in the environment of the vehicle or robot whose presence is indicated by the input data x.

In a particularly advantageous embodiment of the present, the neurons of the set D are implemented on a hardware platform whose resources are not sufficient for an implementation of the full set N of neurons. In particular, depending on the input data x, the neurons can then share the hardware resources in changing subsets A(x) or D(x). In this way, hardware resources can be utilized effectively, and unnecessary resources do not need to be installed on the hardware platform in the first place. The cost savings are somewhat comparable to car sharing, where not as many vehicles are kept as there are users, but only as many vehicles as are expected to be used at the same time. In this way, all users can manage all their transportation tasks while significantly reducing overall costs for purchasing and maintaining vehicles.

In mobile applications in vehicles, in addition to the cost advantage there is the fact that the dimensioning of hardware platforms often imposes additional constraints in terms of installation space, heat generation and/or power consumption.

In another particularly advantageous embodiment of the present invention, one or more neurons from the subset (N\P)\A, whose use was favored by the negative metric but not by the positive metric, are selected for additional inclusion in the set D. In this way, the selection can be further refined by the positive metric, which in turn improves the quality of the output y. While the neurons omitted by pruning usually do not have a significant impact on the quality of the output y, the selection based on the positive metric can certainly represent a compromise between the number of selected neurons on the one hand and the quality of the output y on the other.

In a particularly advantageous embodiment of the present invention, the number of additional neurons to be included in the set D is determined on the basis of a given budget of computing capacity. For example, if the employed hardware platform has the capacity to process a certain number of neurons and the set A(x) of neurons selected by the positive metric for processing a specific input datum x does not yet exhaust this capacity, the capacity can be filled with additional neurons and thus fully utilized. The best quality of the output y tends to be achieved when as many neurons as possible are used within the available hardware resources. This is somewhat comparable to the fact that the best results in exams can be achieved when the allotted work time is fully utilized.

In an example embodiment of the present invention, it is thus particularly advantageous to establish the budget of computing capacity as the total number |D| of neurons in the set D.

In another particularly advantageous embodiment, the neurons from the subset (N\P)\A are selected in descending order of importance for processing the specific input data x. In this way, the gain in quality of the output y per additional added neuron can be maximized.

For example, the order of importance can be established on the basis of a value determined by the positive metric for these neurons. For example, the positive metric can from the outset be based on determining values for all neurons from the subset N\P. For example, neurons whose value exceeds a given threshold value or the top n neurons with the highest values can be included in set A. Proceeding from this, the set D can then be expanded seamlessly without fundamentally changing the mode of operation.

In another particularly advantageous embodiment of the present invention, the negative metric evaluates the neurons independently of specific input data x. Then, for example, a pruning performed once with the negative metric can in particular be reused for many specific input data x. In particular, one and the same pruning can also be used for very different domains and/or distributions of input data x.

In another particularly advantageous embodiment of the present invention, a neural network is selected in which inputs fed to each neuron are aggregated by forming a weighted sum to activate this neuron. The negative metric can then evaluate the neurons at least on the basis of the weights in this weighted sum. If the neurons make no or very little contribution to the weighted sum, they cannot make a large contribution to the output y either.

In another particularly advantageous embodiment of the present invention, the positive metric maps the specific input data x to a hash value H(x) with reduced dimensionality. It then determines the hash value h* most similar to H(x) from a given look-up table in which hash values h are stored in association with information about the participation of neurons. Finally, the positive metric uses the information stored in the look-up table in association with this hash value h* to evaluate neurons from the subset N\P. For example, it can be stored in the table on a binary basis that certain neurons are activated and certain other neurons are not. However, specific activation strengths, for example, can also be stored in the table. The hash function H is then advantageously designed in such a way that it maps similar input data x to similar hash values H(x). Such a location-sensitive hash function H is therefore of a different type than, for example, a cryptographically secure hash function that also maps only minimally different input data x to completely different hash values. An example is so-called locally sensitive hash functions, LSH, which ideally map similar input data x to the same output (in the same “bucket”). Searching for information using the look-up table can be significantly faster than calculating it directly. In particular, the dimensionality of the hash values H(x) can be used to establish, for example, how strongly the information is discretized with regard to the evaluation of neurons.

However, the positive metric can also include, for example, any approximate nearest neighbor search (ANNS) or another metric that estimates the contribution of neurons to the processing of a specific input datum x without having to carry out this processing in its entirety. The calculation of the positive metric costs computing time which must be weighed against the savings due to the reduced number of ultimately calculated neurons.

In a further particularly advantageous embodiment of the present invention, a preselection of those neurons which significantly contribute to the processing of the specific input data x is made on the basis of values of the positive metric for a plurality of input data \tilde{x} from a domain and/or distribution x to which the specific input data x also belong. The final check as to which neurons are important for processing a specific input datum x can then be restricted to this preselection, which accordingly reduces the computational effort.

In a further advantageous embodiment of the present invention, a control signal is determined from the output data y generated by the neural network from the input data. A vehicle, a driver assistance system, a robot, a quality control system, a system for monitoring areas, and/or a medical imaging system is controlled with the control signal. Given the equipment of the hardware platform used to implement the neural network, the improved quality of the output data y then increases the probability that the reaction performed by the respective controlled technical system in response to the control signal is appropriate to the situation embodied by the input data x. The input data x can in particular be, for example, measurement data that were recorded with at least one sensor.

According to the present invention, the method can in particular be wholly or partially computer-implemented. For this reason, the present invention also relates to a computer program comprising machine-readable instructions which, when executed on one or more computers, cause said computer(s) to carry out the method described above. In this sense, control devices for vehicles and embedded systems for technical devices, which are also capable of executing machine-readable instructions, are also to be regarded as computers.

The present invention also relates to a machine-readable data carrier and/or to a download product comprising the computer program. A download product is a digital product that can be transmitted via a data network, i.e. can be downloaded by a user of the data network, and can, for example, be offered for immediate download in an online shop.

Furthermore, according to an example embodiment of the present invention, a computer can be equipped with the computer program, with the machine-readable data carrier, or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 for processing input data x with a neural network 1, according to the present invention.

FIGS. 2A-2C show an illustration of how the neurons 11-19 to be used for processing input data x depend on the input data x, according to an example embodiment of the present invention.

### DETAILED DESCRIPTION OF EXAMPLE EMBODIMENTS

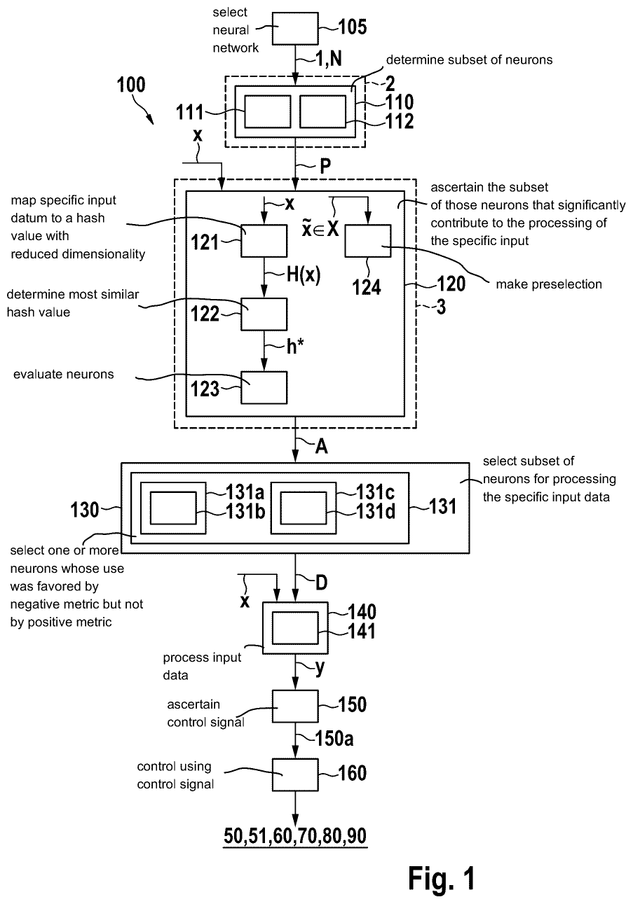

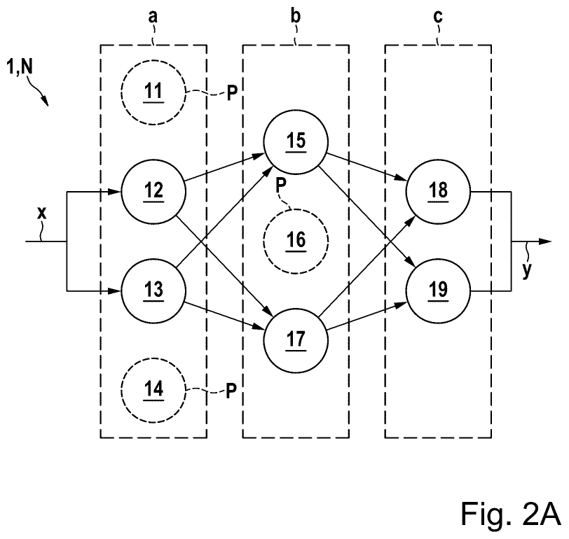

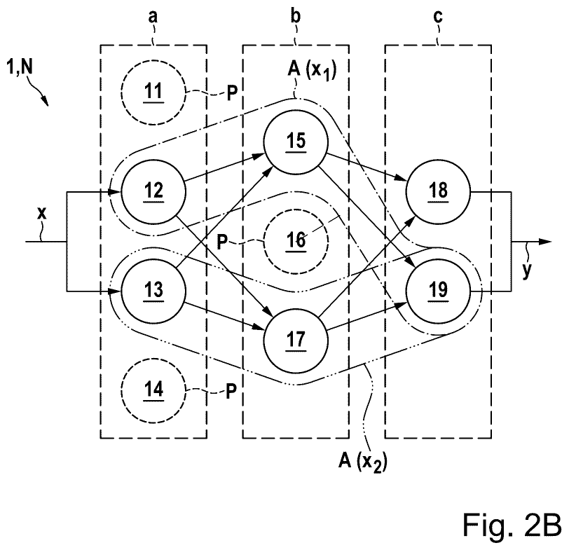

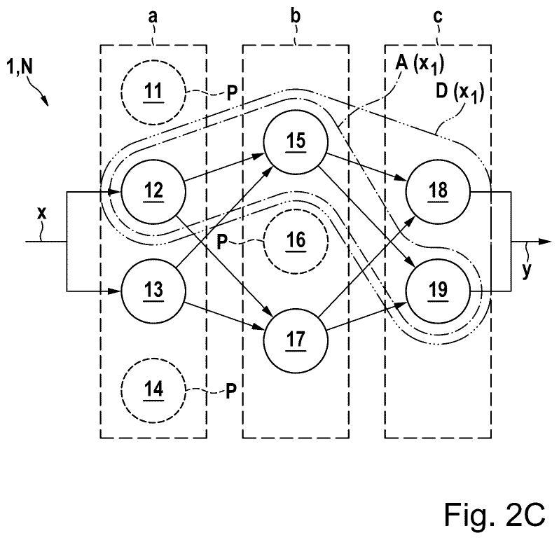

FIG. 1 shows a schematic flow diagram of an exemplary embodiment of the method 100 for processing input data x with a neural network 1. The neural network 1 comprises a set N of nine neurons 11-19. Their interaction is explained in more detail in connection with FIGS. 2A-2C.

In step 110, according to a given negative metric 2, the subset P⊂N of neurons 11-19 is determined whose use can be omitted without unduly impairing the performance of the neural network 1. A criterion for a non-significant impairment of performance can, for example, be that the neural network 1 achieves at least a specified accuracy when processing input data x from a given set of test or validation data, even without using the neurons in the subset P. This accuracy can be ascertained, for example, by comparing the output data y ascertained from the test or validation data with the target outputs with which the test or validation data are labeled.

The evaluation of the neurons 11-19 by the negative metric 2, which can be used, for example, to ascertain the order of the neurons 11-19 to be omitted, can be carried out according to block 111 independently of specific input data x. For such an evaluation, for example parameters and/or coefficients can in particular be used which are assigned to the neurons 11-19 in network 1 and characterize the behavior of network 1.

In the example shown in FIG. 1, in step 105, a neural network 1 is selected in which inputs that are supplied to each neuron 11-19 are aggregated by forming a weighted sum to activate this neuron 11-19. According to block 112, the negative metric 2 can then evaluate the neurons 11-19 at least on the basis of the weights in this weighted sum.

In step 120, according to a given positive metric 3, the subset A⊂(N\P) of those neurons 11-19 that significantly contribute to the processing of the specific input data x is ascertained from the subset N\P. This means that the path on which an input datum x passes through network 1 depends on this input datum x.

According to block 121, the positive metric 3 can map the specific input datum x to a hash value H(x) with reduced dimensionality. It can then, according to block 122, determine the hash value h* most similar to H(x) from a given look-up table in which hash values h are stored in association with information about the participation of neurons 11-19. According to block 123, the information stored in the look-up table in association with this hash value h* can then be used to evaluate neurons 11-19 from the subset N\P.

According to block 124, a preselection of those neurons (11-19) that significantly contribute to the processing of the specific input data x can be made based on values of the positive metric (3) for a plurality of input data \tilde{x} from a domain and/or distribution x to which the specific input data x also belong.

In step 130, for processing the specific input data x, a subset D⊂N of neurons 11-19 is selected, which is a superset D⊇A of the set A. In the simplest case, set A can simply be passed on as set D. However, FIG. 1 shows examples of how set D can still be meaningfully extended compared to set A.

In particular, according to block 131, for example, one or more neurons 11-19 from the subset (N\P)\A, whose use was favored by the negative metric 2 but not by the positive metric 3, can be selected for additional inclusion in the set D.

For example, according to block 131a, the number of additional neurons 11-19 to be included in the set D can be determined on the basis of a given budget of computing capacity. According to block 131b, this budget can be defined in particular, for example, as the total number |D| of neurons 11-19 in the set D.

According to block 131c, the neurons 11-19 can be selected from the subset (N\P)\A, in particular for example, in descending order of importance, for processing the specific input data x. This order of importance can be determined according to block 131d, in particular for example, based on a value determined by the positive metric 3 for these neurons 11-19.

In step 140, the input data x are processed into the desired output data y using the neurons 11-19 of the set D.

In particular, according to block 141, the neurons 11-19 of the set D can be implemented in particular for example on a hardware platform whose resources are insufficient for an implementation of the full set N of neurons 11-19.

In the example shown in FIG. 1, in step 150 a control signal 150a is ascertained from the output data y. In step 160, a vehicle 50, a driver assistance system 51, a robot 60, a system 70 for quality control, a system 80 for monitoring areas, and/or a system 90 for medical imaging, is controlled with this control signal 150a.

FIG. 2A illustrates the architecture of neural network 1 with neurons 11-19 which together form the set N.

Neurons 11-19 are arranged in three layers a, b, c. The first layer a is the input layer which receives the input data x and contains neurons 11-14. The second layer b is a hidden layer within the neural network 1 which contains the neurons 15-17. The third layer c is the output layer which outputs the output data y from the neural network 1 and contains the neurons 18 and 19.

In the example shown in FIG. 2A, the negative metric 2 was used to determine that the use of the dashed neurons 11, 14 and 16 can be omitted without unduly affecting the performance of the neural network 1. These neurons 11, 14 and 16 form the set P. After omitting these neurons 11, 14 and 16, only the paths marked with arrows are available in network 1 for processing the input data x to the output data y. In this case, the example shown in FIG. 2A is purely illustrative. In real, complex neural networks 1, far more neurons 11-19 can be omitted than the third shown in FIG. 2A, namely frequently more than 80 percent and in extreme cases up to 99 percent.

FIG. 2B shows by way of example how the set A of those neurons 11-19 that significantly contribute to the processing of specific input data x depends on these input data x. Shown are the set A (x₁) of neurons 12, 15 and 19 which significantly contribute to the processing of a first input datum x₁, as well as the set A (x₂) of neurons 13, 17 and 19 which significantly contribute to the processing of a second input datum x₂.

The sets A (x₁) and A (x₂) are in each case selected from the subset N\P of those neurons 11-19 that have not yet been excluded from processing by the negative metric 2. They in each case contain only three of the nine neurons 11-19 overall. The input data x₁ and x₂ can thus be processed into output data y even on a hardware platform that is only capable of implementing a maximum of three neurons. For example, after ascertaining the sets A (x₁) and A (x₂), the hardware platform can be configured accordingly. FIG. 2C shows an example of how the set A(x₁) of neurons 12, 15 and 19, which significantly contribute to the processing of a first input datum x₁, can be meaningfully extended to a superset D(x₁) of neurons, by use of which the input datum x₁ can be processed into output data y. Here, the neuron 18 has been specifically included in the superset D(x₁).

1-15. (canceled)

16. A method for processing input data x with a neural network that includes a set N of neurons, the method comprising the following steps:
determining, according to a given negative metric, a subset P⊂N of neurons whose use can be omitted without unduly impairing a performance of the neural network;
determining, according to a given positive metric, a subset A⊂(N\P) of those neurons that significantly contribute to processing of the input data x is determined from the subset N\P;
selecting, for processing the input data x, a subset D⊂N of neurons, which is a superset D⊇A of the subset A;
processing the input data x into output data y using neurons of the superset D.

17. The method according to claim 16, wherein the neurons of the superset D are implemented on a hardware platform whose resources are insufficient for an implementation of all of the neurons of the set N of neurons.

18. The method according to claim 16, wherein one or more neurons from a subset (N\P)\A whose use was favored by the negative metricbut not by the positive metric, are selected for additional inclusion in the superset D.

19. The method according to claim 18, wherein a number of the one or more neurons to be included in the superset D is determined based on a given budget of computing capacity.

20. The method according to claim 19, wherein the given budget of computing capacity is established as a total number |D| of neurons in the superset D.

21. The method according to claim 18, wherein the neurons from the subset (N\P)\A are selected in descending order of importance for processing the input data x.

22. The method according to claim 21, wherein the order of importance is established based on a value determined by the positive metric for the neurons from the subset (N\P)\A.

23. The method according to claim 16, wherein the negative metric evaluates the neurons of the set N of neurons independently of the input data x.

24. The method according to claim 16, wherein:
a neural network is selected in which inputs that are supplied to each neuron are aggregated by forming a weighted sum to activate the neuron, and
the negative metric evaluates the neurons at least based on the weights in the weighted sum.

25. The method according to claim 16, wherein the positive metric:
maps the input data x to a hash value H(x) with reduced dimensionality,
ascertains a hash value h* most similar to H(x) from a given look-up table in which hash values h are stored in association with information about participation of neurons, and
uses the information stored in the look-up table in association with the hash value h* to evaluate neurons from the subset in N\P.

26. The method according to claim 16, wherein a preselection of those neurons which significantly contribute to the processing of the specific input data x is made based on values of the positive metric for a plurality of input data \tilde{x} from a domain and/or distribution X to which the input data x also belong.

27. The method according to claim 16, further comprising:
determining a control signal from the output data y; and
controlling, using the control signal: (i) a vehicle, and/or (ii) a driving assistance system, and/or (iii) a robot, and/or (iv) a system for quality control, and/or (v) a system for monitoring areas, and/or (vi) a system for medical imaging.

28. A non-transitory machine-readable data carrier on which is stored a computer program for processing input data x with a neural network that includes a set N of neurons, the computer program, when executed by one or more computers, causes the one or more computers to perform the following steps:
determining, according to a given negative metric, a subset P⊂N of neurons whose use can be omitted without unduly impairing a performance of the neural network;
determining, according to a given positive metric, a subset A⊂(N\P) of those neurons that significantly contribute to processing of the input data x is determined from the subset N\P;
selecting, for processing the input data x, a subset D⊂N of neurons, which is a superset D⊇A of the subset A;
processing the input data x into output data y using neurons of the superset D.

29. One or more computers, comprising:
a non-transitory machine-readable data carrier on which is stored a computer program for processing input data x with a neural network that includes a set N of neurons, the computer program, when executed by one or more computers, causes the one or more computers to perform the following steps:
determining, according to a given negative metric, a subset P⊂N of neurons whose use can be omitted without unduly impairing a performance of the neural network;
determining, according to a given positive metric, a subset A⊂(N\P) of those neurons that significantly contribute to processing of the input data x is determined from the subset N\P;
selecting, for processing the input data x, a subset D⊂N of neurons, which is a superset D A of the subset A;
processing the input data x into output data y using neurons of the superset D.
